(19) United States
(12) Patent Application Publication
(10) Pub. No.: US 2006/0210286 A1
(43) Pub. Date: Sep. 21, 2006

(54) Method of detecting double feed in image forming apparatus

(75) Inventor: Chong-Wan Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/376,419

(22) Filed: Mar. 16, 2006

(30) Foreign Application Priority Data
Mar. 17, 2005 (KR) 2005-0022187

(51) Int. Cl. G03G 15/00

(52) U.S. Cl. 399/16

(57) ABSTRACT

Provided is a method of detecting double feed in an image forming apparatus. The method includes generating a barcode signal by detecting a barcode pattern using a reflective optical sensor while conveying a sheet of paper on which a barcode is printed, and determining that double feed has occurred when a level of the barcode signal is greater than a level of a predetermined reference signal.

### PRIORITY

This application claims the benefit under 35 U.S.C. § 119(a) of Korean Patent Application No. 10-2005-0022187, filed on Mar. 17, 2005, in the Korean Intellectual Property Office, the entire disclosure of which is hereby incorporated by reference.

### BACKGROUND OF THE INVENTION

1. Field of the Invention

The present invention relates to an apparatus and method of detecting double feed in an image forming apparatus.

2. Description of the Related Art

An image forming apparatus picks up and transfers a sheet of paper from a paper containing unit and prints an image onto the sheet of paper. Occasionally, two sheets of paper may be picked up at the same time. This is referred to as “double feed.” Double feed causes a paper jam and the omission of a print image (especially, an image at the top edge of the paper). Although there have been various attempts to solve the problem of double feed, it has not fundamentally been solved.

With the development of high resolution and color image forming apparatuses, photo images are likely to be printed. To achieve a high quality photographic image, photo paper is used instead of a general paper. For example, an inkjet image forming apparatus uses paper made to prevent ink bleed, and thermal image forming apparatus uses paper having a thermal ink layer. These types of photo papers are more expensive than general paper. Thus, the occurrence of double feed creates loss of expensive photo paper.

### SUMMARY OF THE INVENTION

A barcode is printed on a sheet to record information such as size, properties, manufacturing serial number and manufacturer. The sheet can be paper, plastic, vellum, or any item that can be printed upon. In particular, photo paper generally has a barcode to indicate optimal print conditions according to paper size and properties. An image forming apparatus can employ a sensor to read the barcode and thereby detect properties of the paper. The image forming apparatus can then set optimal print conditions based on those properties.

Embodiments of the present invention provide a method of detecting double feed using a barcode and a sensor.

Embodiments of the present invention also provide a method for preventing defective printing and loss of paper by detecting double feed.

According to an aspect of the present invention, there is provided a method of detecting double feed in an image forming apparatus. The method includes generating a barcode signal by detecting a barcode pattern using a reflective optical sensor while conveying a sheet upon which a barcode is printed. The method further includes determining occurrence of double feed when the barcode signal level is greater than that of a predetermined reference signal.

The method may further include counting the number of barcode signals and determining occurrence of double feed when the counted number is greater than a predetermined reference number.

The method may further include detecting a barcode signal and establishing the barcode signal as a reference signal.

According to yet another aspect of the present invention, there is provided a method of detecting double feed in an image forming apparatus. The method includes generating a detecting signal using a reflective optical sensor by detecting a pattern . The method further includes determining that double feed has occurred when the level of the detecting signal is different from a predetermined reference signal level.

The method may further include generating a detection signal by detecting a pattern. The detection signal is compared to a reference signal in order to determine whether double feed has occurred. The reference signal can be predetermined or established by equating it to the detection signal generated when no double feed occurs. Thus, double feed occurs when the detection signal and the reference signal are different. The detection signal and the reference signal can be compared on the basis of signal levels.

According to another aspect of the present invention, there is provided an image forming apparatus adapted to detect the occurrence of double feed. The apparatus includes a reflective optical sensor adapted to generate a detection signal by detecting a pattern. The apparatus further includes a control unit adapted to determine the occurrence of double feed when the detection signal has a level that is different from a predetermined reference signal level.

According to yet another aspect of the present invention, there is provided a computer readable medium having stored thereon instructions for controlling an image forming apparatus to detect the occurrence of a double feed. The computer readable medium includes a first set of instructions adapted to control the image forming apparatus to generate a detection signal by detecting a pattern using a reflective optical sensor. The computer readable medium further includes a second set of instructions adapted to control the image forming apparatus to determine that double feed has occurred if the detection signal has a level that is different from a predetermined reference signal level.

### BRIEF DESCRIPTION OF THE DRAWINGS

The above and other features and advantages of the present invention will become more apparent from the following detailed description of exemplary embodiments thereof with reference to the attached drawings in which:

FIGS. 1 and 2 schematically illustrate an exemplary structure of an image forming apparatus that adopts a method of detecting double feed according to an embodiment of the present invention;

FIG. 3 depicts a plan view of an example of a sheet of paper to use with an embodiment of the present invention;

FIG. 4 illustrates a cross-sectional view of the sheet of paper of FIG. 3;

FIG. 5 depicts a graph showing an exemplary of a reference signal;

FIG. 6 depicts a graph showing an exemplary of a barcode signal when double feed occurs;

FIGS. 7 and 8 depict views illustrating two types of double feed operation; and

FIG. 9 depicts a view illustrating an example of a medium on which a pattern for detecting double feed is printed.

Throughout the drawings, like reference numbers should be understood to refer to like elements, features and structures.

### DETAILED DESCRIPTION OF EXEMPLARY EMBODIMENTS

Hereinafter, exemplary embodiments of the present invention will be described in detail with reference to the accompanying drawings.

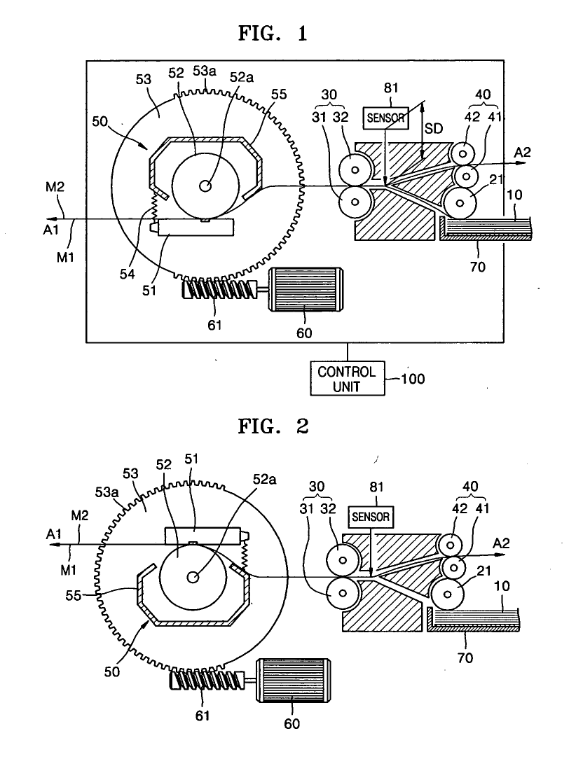

FIG. 1 schematically illustrates the structure of an image forming apparatus that adopts a method of detecting double feed according to an embodiment of the present invention. Referring to FIG. 1, the image forming apparatus includes a cassette (containing unit) 70 that stores sheets of paper, a feeding unit 30 that conveys the paper, a print unit 50 that prints an image onto the paper, and a discharging unit 40 that discharges the paper. The print unit 50 can print an image onto the paper using such methods as, but not limited to, an electrophotographic method, an ink-jet method, a thermal transfer method, or a direct thermal method.

The image forming apparatus illustrated in FIG. 1 is an example of a direct thermal type image forming apparatus that prints an image by applying heat to a sheet of paper having thermal sensitive layers. Referring to FIG. 1, the print unit 50 includes a thermal printing head (TPH) 51, which forms an image by applying heat to a sheet of paper 10, and a platen roller 52, which supports the paper while facing the TPH 51. An elastic member 54 pulls the TPH 51 towards the platen roller 52. Cassette 70 contains paper 10. A pick-up roller 21 is installed in the upper side of the cassette 70. The feeding unit 30 conveys the sheets of paper 10. In one embodiment, feeding unit 30 includes a feed roller 31 and an idle roller 32 facing the feed roller 31. The discharging unit 40 preferably includes a discharging roller 41 that rotates while facing the pick-up roller 21, and an idle roller 42 facing the discharging roller 41.

The paper 10 used for the image forming apparatus according to one embodiment of the present invention may have a structure as shown in FIG. 4. The paper 10 includes thermal sensitive ink layers L1 and L2 that respectively reveal predetermined colors in response to heat applied to both sides of a base sheet S, that is, a first surface M1 and a second surface M2. Each thermal sensitive ink layer L1 and L2 may have a single layer structure or a multi-layer structure for representing two or more colors. In a first embodiment, the thermal sensitive ink layer L1 includes two layers to reveal yellow and magenta colors, respectively, and thermal sensitive ink layer L2 includes one layer to reveal a cyan color. Yellow and magenta layers of the thermal sensitive ink layer L1 can selectively reveal color as a function of temperature and heating time of TPH 51. For example, if layer L1 is heated at high temperature for a short period of time, a yellow color is revealed, whereas when layer L1 is heated at low temperature for a long period of time, a magenta color is revealed. If base sheet S is transparent, a color image is displayed by overlapping yellow, magenta, and cyan colors, each of which is revealed on the thermal sensitive ink layers L1 and L2. U.S. Patent Application Publication No. US2003/0125206 discloses an example of paper 10. If base sheet S is opaque, different images can be printed on first and second surfaces M1 and M2, and therefore duplex printing is possible. It should be understood that the technical scope of the method of detecting double feed according to embodiments of the present invention is not limited by the structure of the ink layers L1 and L2 of first and second surfaces M1 and M2 of paper 10, and the printing method of the print unit 50.

To apply heat to both sides (M1 and M2) of paper 10, the TPH 51 is moved to a first position (referring to FIG. 1) where the TPH 51 faces the first surface M1 of paper 10, or a second position (referring to FIG. 2) where the TPH 51 faces the second surface M2 of paper 10. In the image forming apparatus of one embodiment, the TPH 51 is rotated about a rotation axis 52a of platen roller 52, and then moved to the first or second position. The cases in which the TPH 51 is moved to the first position and the second position are illustrated in FIGS. 1 and 2. Referring to FIGS. 1 and 2, a supporting bracket 53 rotates concentrically to the rotation axis 52a of platen roller 52. The TPH 51 is coupled to the supporting bracket 53. A gear portion 53a is formed on the outer circumference of the supporting bracket 53. A worm gear 61 engages gear portion 53a and is coupled to a rotation axis of motor 60. According to this structure, the supporting bracket 53 is rotated as motor 60 is driven, and thus TPH 51 can be moved to the first or second position, as shown in FIGS. 1 and 2, respectively. A guide member 55 is coupled to supporting bracket 53 and guides paper 10 between the TPH 51 and the feeding unit 30.

As shown in FIG. 1, paper 10 is picked up from cassette 70 and is fed in a first direction A1 and routed between the TPH 51 and the platen roller 52. When paper 10 is fed in a second direction A2, the TPH 51 prints a color image of yellow and magenta onto the first surface M1 of the paper 10 by applying heat to the first surface M1. When printing on the first surface M1 is complete, motor 60 rotates the supporting bracket 53 to move TPH 51 to the second position as shown in FIG. 2. Paper 10 is fed again in the first direction A1 and routed between TPH 51 and the platen roller 52. When paper 10 is fed again in the second direction A2, the TPH 51 prints a cyan image on the second surface M2 of paper 10. When printing is complete, paper 10 is discharged by the discharging unit 40.

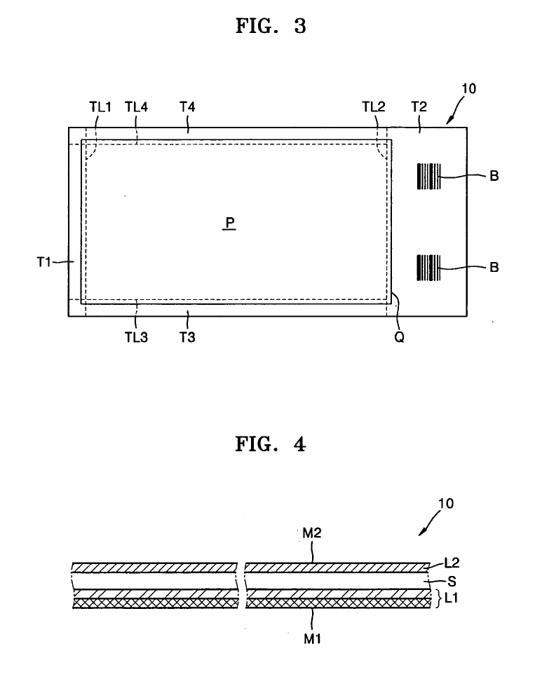

The properties of paper 10 may affect the printed image quality. For example, when print unit 50 prints an image onto a sheet of paper using a direct thermal method, the chemical composition of thermal sensitive layers may be slightly different according to manufacturer and manufacturing lots. Image quality can be optimized by controlling the heating temperature and heating time of a thermal printing head to reflect paper property differences. As described above, information such as size, properties, manufacturing number, and manufacturer, can be contained in a barcode B printed on paper 10, as shown in FIG. 3.

Paper 10, in particular a sheet of paper onto which a photo image is to be printed, may have a printing area P, and non-printing areas T1 and T2. Paper 10 may further have non-printing areas T3 and T4. The printing area P and the non-printing areas T1, T2, T3 and T4 may be divided by lines TL1, TL2, TL3 and TL4. Lines TL1, TL2, TL3, and TL4 can be, though not limited to, printed dashed, scored or perforated for demarking the printed area from the non-printed area. To perform borderless printing, an image is printed such that the image is slightly larger than the printing area P as shown by solid line Q in FIG. 3. Non-printing areas T1, T2, T3, and T4 are then removed along the lines TL1, TL2, TL3, and TL4. Thus, borderless printing that looks like a printed photo can be implemented. The barcode B is generally printed on the non-printing area T1 or T2 as shown in FIG. 3.

A reflective optical sensor is employed as a sensor 81. Sensor 81 reads information contained in barcode B by scanning light onto the barcode and detecting the light reflected from a barcode pattern. The light emitted from a light emitting portion of sensor 81 is reflected by barcode B and then received by a light receiving portion of sensor 81. The light receiving portion generates a voltage signal corresponding to the intensity of received light. This voltage signal is sent to a control unit 100. Control unit 100 converts the voltage signal (barcode signal) to, for example, a high (H) signal and a low (L) signal, and recognizes the information recorded on the barcode B by combining H and L signals.

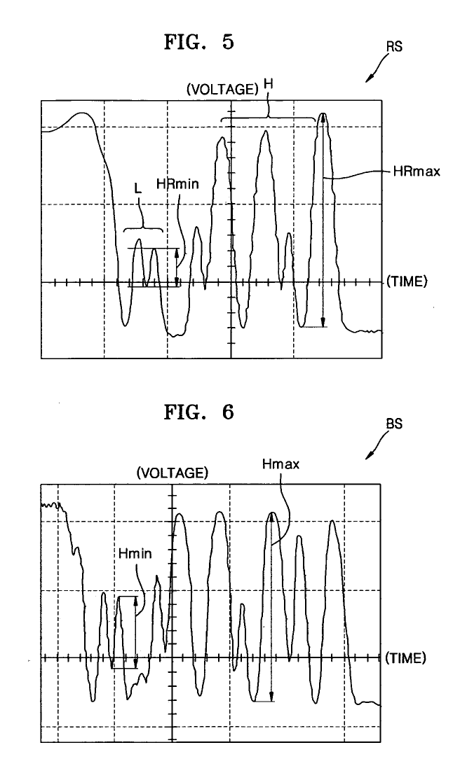

When a sheet of paper is extracted from cassette 70, a barcode signal detected by sensor 81 is generated, as shown in FIG. 5. In FIG. 5, a low voltage signal level (L) corresponds to a black bar of barcode B, and a high voltage signal level (H) corresponds to the background of barcode B. Each black bar corresponds to a signal valley of the voltage signal generated by sensor 81. Thus, a wide black bar can be represented by a wide signal valley which can be converted to multiple low signals by the control unit 100. Control unit 100 translates the information read from barcode B into paper size, properties, manufacturing number, and manufacturer, and controls print unit 50 in response to this information.

Sensor 81 is installed at a fixed position. Thus, when two or more sheets of paper 10 are picked up from cassette 70 and fed (that is, when a double feed occurs), the distance between sensor 81 and the uppermost paper 10 is less than the distance between sensor 81 and paper 10 when a double feed does not occur. One method of detecting the occurrence of double feed according to an aspect of the present invention is characterized by sensing a change in sensing distance SD between sensor 81 and paper 10, and determining whether two or more sheets of paper have been fed. While sensing distance SD is shown in an exaggerated fashion within FIGS. 1 and 2, the sensing distance SD is actually on the order of several millimeters, preferably within one millimeter. The voltage level of barcode signal BS is changed depending on the sensing distance SD. Therefore, when the voltage level of barcode signal BS is detected and compared to a predetermined voltage level, it can be determined whether the sensing distance SD has changed. Thus, the occurrence of a double feed can be known. FIG. 5 depicts a barcode signal RS graph indicating that a double feed has not occurred, that is, a successful paper feed was accomplished.

FIG. 6 depicts a graph indicating an example of the barcode signal BS when a double feed does occur. Referring to FIG. 6, the maximum level Hmax is not greatly changed from that of the maximum level HRmax of FIG. 5 (when a double feed has not occurred). On the other hand, the minimum level Hmin, shown in FIG. 6, is greater than the minimum level HRmin of FIG. 5. Generally, the level of barcode signal BS when a double feed occurs is greater than the level of barcode signal BS when a double feed has not occurred.

Thus, by comparing barcode signal BS levels relative to changes in the distance between sensor 81 and paper 10, it can be known whether a double feed has occurred. A barcode signal (for example, the barcode signal shown in FIG. 5) when a double feed does not occur can be predetermined as a reference signal RS in control unit 100. Control unit 100 compares the barcode signal BS detected by sensor 81 with the reference signal RS, and determines that a double feed has occurred when the level of the barcode signal BS is greater than that of the reference signal RS. More specifically, control unit 100 extracts the minimum level Hmin of barcode signal BS and compares this with the minimum level HRmin of the reference signal RS. Control unit 100 can determine that a double feed has occurred when the minimum level Hmin is greater than the minimum level HRmin of the reference signal RS.

The maximum and minimum levels, Hmax and Hmin, of barcode signal BS may be influenced by the properties of paper 10. Table 1 presents an example of measuring the ratio Hmin/Hmax between the maximum level Hmax and the minimum level Hmin according to the distance between paper 10 and sensor 81 when using KIR-3001A of Kodenshi Korea as sensor 81. Sensors from other manufacturers may also be used as well. Referring to Table 1, as sensor 81 and paper 10 get closer to each other, the value of Hmin/Hmax is increased. Control unit 100 compares the ratio of the minimum level Hmin to the maximum level Hmax of barcode signal BS with the ratio of minimum level HRmin to the maximum level HRmax of reference signal RS. Control unit 100 can then determine that a double feed has occurred when the ratio of the minimum level Hmin to the maximum level Hmax of barcode signal BS is greater than the ratio of the minimum level HRmin to the maximum level HRmax of the reference signal RS.

TABLE 1

| | | Distance between the paper and sensor | | | |
|---|---|---|---|---|---|
| | | 0.3 mm | 0.46 mm | 0.54 mm | 0.75 mm |
| Hmin/Hmax (%) | #1 | 53 | 37 | 32 | 25 |
| | #2 | 41 | 35 | 28 | 19 |
| | #3 | 43 | 35 | 33 | 17 |
| | #4 | 49 | 38 | 36 | 25 |

In control unit 100, the minimum level HRmin or the ratio of the minimum level HRmin to the maximum level HRmax of the reference signal RS may be predetermined.

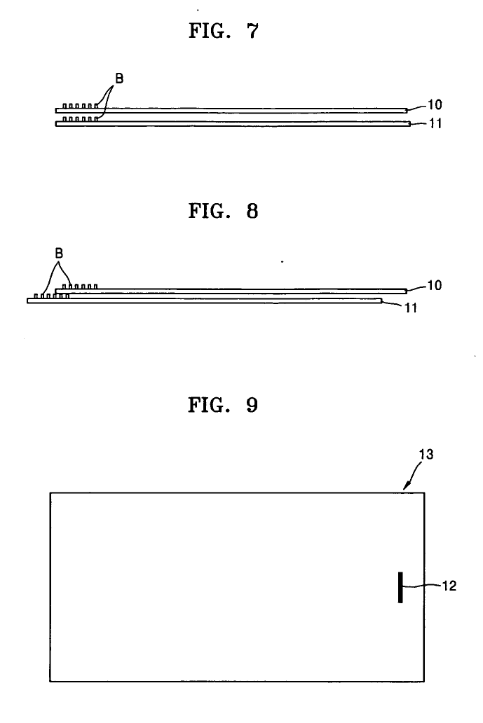

Double feed can occur in two cases. One is when two sheets of paper 10 and 11 completely overlap each other as shown in FIG. 7; the other is when paper 10 and 11 partially overlap each other as shown in FIG. 8. The occurrence of double feed can be detected by comparing the level of the barcode signal BS detected by sensor 81 with the level of reference signal RS. To distinguish between the two cases of double feed, control unit 100 counts the number of barcode signals BS. The number of barcode signals BS is a function of the amount of information indicated by barcode B, and may be predetermined, for example, as a reference number in control unit 100.

When the complete-overlap-type double feed occurs, as shown in FIG. 7, the number of barcode signals BS will be the same as the predetermined reference number. When the partial-overlap-type double feed occurs, as shown in FIG. 8, the number of the barcode signals BS will be greater than the predetermined reference number. Thus, control unit 100 can distinguish between the two cases of double feed by counting the number of barcode signals BS and comparing the number of barcode signals BS to the reference number.

When double feed occurs, control unit 100 can inform a user of the event by causing an alarm, such as triggering a visual and/or audible warning unit (not shown). When the complete-overlap-type double feed occurs, as shown in FIG. 7, the image can still be printed on paper 10, except for the case where an image is printed on both sides of the paper (duplex printing). When the partial-overlap-type double feed occurs, as shown in FIG. 8, an end of the sheet of paper is recognized using the number of the barcode signals BS, and the image is printed on paper 10. Thus, the image is not omitted from paper 10. When duplex printing is performed, in both cases of double feed, it is preferable to stop printing and discharge paper 10 and 11. Alternatively, the user can be informed of the double feed event.

Thickness of paper 10 can vary. When the thickness of paper 10 is variant, the sensing distance SD is changed as well and it is difficult to correctly detect whether double feed has occurred. Detecting double feed in accordance with an aspect of the present invention further includes setting the reference signal RS. Specifically, when an image is printed on paper 10, and paper 10 has a different thickness, barcode signal BS is detected while paper 10 is being conveyed and the detected barcode signal BS is set to the reference signal RS in control unit 100. Thereafter, the occurrence of double feed is detected based on this baseline reference signal RS.

Detecting the level of barcode signal BS is not the only method of detecting whether the sensing distance SD between sensor 81 and paper 10 has changed. For example, a pattern 12 for detecting double feed is printed on a sheet of paper 13 as shown in FIG. 9, and sensor 81 may detect the pattern. Pattern 12 for detecting double feed may be a black bar as shown in FIG. 9. It can be expected from the case of detection of barcode B that a signal level of pattern 12—when double feed occurs—is detected by sensor 81 and is different from the signal level (a reference level) of pattern 12 when no double feed occurs. In this case, when a paper having a different thickness is used, the reference level is newly set in control unit 100 as described above.

These and other embodiments of the method of detecting double feed can be applied not only to direct thermal type image forming apparatus, but also to image forming apparatus that can print an image onto a sheet of paper using various methods such as the electrophotographic method, inkjet method, and thermal transfer method.

As described above, in a method of detecting double feed according to various aspects of the present invention, double feed is detected and omission of an image or paper jam and loss of expensive photo paper due to defective printing caused by double feed can be prevented. Moreover, double feed can be detected using a barcode and sensor for detecting the barcode without additional components.

Further, a pattern for detecting double feed can be printed on the paper so that double feed can be detected by detecting the pattern.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of detecting double feed in an image forming apparatus, the method comprising:
generating a detection signal by detecting a pattern using a reflective optical sensor; and
determining the occurrence of double feed when the detection signal has a level that is different from a predetermined reference signal level.

2. The method of claim 1, wherein the pattern is printed on a sheet.

3. The method of claim 2, wherein the reflective optical sensor is configured to measure a sensing distance between the sensor and the sheet.

4. The method of claim 3, wherein double feed is determined by a change in the sensing distance.

5. The method of claim 1, wherein the image forming apparatus has a control unit configured to assess variations in signal level.

6. The method of claim 5, wherein the control unit indicates occurrence of double feed by causing an alarm.

7. The method of claim 1, wherein the pattern is a barcode and the detection signal is a barcode signal.

8. The method of claim 7, wherein the barcode contains information comprising sheet size, sheet properties, and sheet manufacturer.

9. The method of claim 7, wherein double feed is determined to occur when the minimum barcode signal level is greater than the minimum reference signal level.

10. The method of claim 7, wherein double feed is determined to occur when a ratio of minimum barcode signal level to maximum barcode signal level is greater than a ratio of minimum reference signal level to maximum reference signal level.

11. The method of claim 7, wherein the predetermined reference signal is equated to the barcode signal generated when double feed has not occurred.

12. The method of claim 7, further comprising:
counting a number of barcode signals and determining that double feed has occurred when the counted number is greater than a predetermined reference number.

13. The method of claim 12, wherein the predetermined reference signal is equated to the barcode signal generated when double feed has not occurred.

14. An image forming apparatus adapted to detect the occurrence of double feed, comprising:
a reflective optical sensor adapted to generate a detection signal by detecting a pattern; and
a control unit adapted to determine the occurrence of double feed when the detection signal has a level that is different from a predetermined reference signal level.

15. The apparatus of claim 14, wherein the pattern is printed on a sheet.

16. The apparatus of claim 15, wherein the reflective optical sensor is configured to measure a sensing distance between the sensor and the sheet.

17. The apparatus of claim 16, wherein double feed is determined by a change in the sensing distance.

18. The apparatus of claim 14, wherein the image forming apparatus has a control unit configured to assess variations in signal level.

19. The apparatus of claim 18, wherein the control unit indicates occurrence of double feed by causing an alarm.

20. A computer readable medium having stored thereon instructions for controlling an image forming apparatus to detect the occurrence of a double feed, comprising:
a first set of instructions adapted to control the image forming apparatus to generate a detection signal by detecting a pattern using a reflective optical sensor; and
a second set of instructions adapted to control the image forming apparatus to determine that double feed has occurred if the detection signal has a level that is different from a predetermined reference signal level.
